(19) United States
(12) Patent Application Publication
(10) Pub. No.: US 2026/0204789 A1
(43) Pub. Date: Jul. 16, 2026

(54) LAMINATE, ANTENNA SUBSTRATE, AND ANTENNA MODULE

(71) Applicant: FUJIFILM Corporation, Tokyo (JP)

(72) Inventors: Yasuyuki SASADA, Kanagawa (JP); Hideki YASUDA, Kanagawa (JP); Makoto UCHIMURA, Kanagawa (JP); Shohei YAMAZAKI, Kanagawa (JP)

(73) Assignee: FUJIFILM Corporation, Tokyo (JP)

(21) Appl. No.: 19/562,713

(22) Filed: Mar. 10, 2026

Related U.S. Application Data
(63) Continuation of application No. PCT/JP2024/032584, filed on Sep. 11, 2024.

(30) Foreign Application Priority Data
Sep. 15, 2023 (JP) 2023-150291

(51) Int. Cl. H01Q 13/08; H01Q 1/38

(52) U.S. Cl. CPC H01Q 13/08; H01Q 1/38

(57) ABSTRACT

Provided are a laminate including a dielectric layer having a relative permittivity of more than 3, and conductor layers, in which two or more conductor layers having different sizes are arranged on one surface side of the dielectric layer, a conductor layer different from the two or more conductor layers is disposed on the other surface side of the dielectric layer, and the two or more conductor layers are arranged to be in the same plane and not to be in contact with each other; and applications thereof.

### CROSS-REFERENCE TO RELATED APPLICATIONS

This application is a continuation of International Application No. PCT/JP2024/032584, filed on Sep. 11, 2024, which claims priority from Japanese Patent Application No. 2023-150291, filed on Sep. 15, 2023. The entire disclosure of each of the above applications is incorporated herein by reference.

### BACKGROUND OF THE INVENTION

### 1. Field of the Invention

The present disclosure relates to a laminate, an antenna substrate, and an antenna module.

### 2. Description of the Related Art

In recent years, communication equipment has been developed to be faster, and a frequency used for communication tends to be very high, and there is a growing demand for electronic components used in the communication equipment to be reduced in size and to be highly densely mounted.

For example, WO2023/120467A discloses an antenna module including a first ground electrode, a dielectric substrate disposed in the vicinity of the first ground electrode, and a first radiator and a second radiator which are disposed on the dielectric substrate in parallel to the first ground electrode and each of which radiates radio waves, in which the second radiator is disposed at a position above the first radiator, the first radiator has, in a plan view in a height direction, an overlapping portion which overlaps with the second radiator and a non-overlapping portion which does not overlap with the second radiator, the dielectric substrate has an upper surface which is located above the second radiator and a first step surface which is located above the non-overlapping portion of the first radiator and below the second radiator, and a high-dielectric layer having a permittivity higher than that of the dielectric substrate is disposed in a peripheral region of the upper surface and a peripheral region of the first step surface.

WO2023/145327A discloses a thermosetting resin composition containing (A) a thermosetting resin and (B) at least one inorganic filler selected from the group consisting of a titanium-based inorganic filler and a zirconium-based inorganic filler, in which a content of particles having a particle diameter of 1.0 μm or less in the component (B) is 30% by volume or less based on the component (B), and discloses that the thermosetting resin composition is used for an antenna module.

### SUMMARY OF THE INVENTION

In an antenna module, it is required to be capable of handling signals of a plurality of high-frequency bands and to be reduced in size.

An object to be achieved by one embodiment of the present disclosure is to provide a laminate and an antenna substrate, which are capable of handling signals of a plurality of high-frequency bands and are suitable for an antenna module.

Another object to be achieved by one embodiment of the present disclosure is to provide an antenna module which is capable of handling signals of a plurality of high-frequency bands.

Specific methods for achieving the object are as follows.

<1>

A laminate comprising:
a dielectric layer having a relative permittivity of more than 3; and
conductor layers,
in which two or more conductor layers having different sizes are arranged on one surface side of the dielectric layer,
a conductor layer different from the two or more conductor layers is disposed on the other surface side of the dielectric layer, and
the two or more conductor layers are arranged to be in the same plane and not to be in contact with each other.

<2>

The laminate according to <1>,
in which, in a case where a relative permittivity is indicated as T and a dielectric loss tangent is indicated as D, the dielectric layer satisfies the following expression A,

T^{0.5}×D≤0.10 Expression A.

<3>

The laminate according to <1> or <2>,
in which the two or more conductor layers are arranged in a staggered manner.

<4>

The laminate according to any one of <1> to <3>,
in which the dielectric layer has a dielectric loss tangent of less than 0.01.

<5>

The laminate according to any one of <1> to <4>,
in which the dielectric layer contains an inorganic filler and a resin.

<6>

The laminate according to <5>,
in which the inorganic filler has a relative permittivity of 6 to 20,000.

<7>

The laminate according to <5> or <6>,
in which the inorganic filler includes at least one selected from the group consisting of barium titanate, strontium titanate, calcium titanate, magnesium titanate, bismuth titanate, zirconium titanate, zinc titanate, titanium dioxide, magnesium oxide, alumina, tantalum pentoxide, and niobium pentoxide.

<8>

The laminate according to any one of <5> to <7>,
in which, in the dielectric layer, a ratio (Do/Di) of a number (Do) of inorganic fillers per unit area in a thickness direction to a number (Di) of inorganic fillers per unit area in an in-plane direction is 0.5 or more.

<9>

The laminate according to any one of <5> to <8>,
in which the resin includes at least one selected from the group consisting of a thermoplastic resin, a thermoplastic elastomer, a semicured product of a thermosetting resin, a cured product of a thermosetting resin, a semicured product of a thermosetting elastomer, and a cured product of a thermosetting elastomer.

<10>

The laminate according to any one of <1> to <9>,
in which the conductor layer has a surface roughness Rc of 1 μm or less on a dielectric layer side.

<11>

The laminate according to any one of <1> to <10>,
in which the two or more conductor layers have different signal frequencies.

<12>

An antenna substrate comprising:
the laminate according to any one of <1> to <11>.

<13>

An antenna module comprising:
the antenna substrate according to <12>, in which the antenna module transmits and receives radio waves having a frequency of 6 GHz to 24 GHz.

<14>

An antenna module comprising:
the antenna substrate according to <12>,
in which the antenna module transmits and receives radio waves having a frequency of 0.5 GHz to 5.9 GHZ.

According to one embodiment of the present disclosure, there are provided a laminate and an antenna substrate, which are capable of handling signals of a plurality of high-frequency bands and are suitable for an antenna module.

In addition, according to one embodiment of the present disclosure, there is provided an antenna module which is capable of handling signals of a plurality of high-frequency bands.

### BRIEF DESCRIPTION OF THE DRAWINGS

FIG. 1 is a schematic plan view schematically showing an arrangement of conductor layers in the laminate according to the present disclosure.

FIG. 2 is a schematic plan view schematically showing an arrangement of conductor layers in a laminate of Example 2.

FIG. 3 is a schematic plan view schematically showing an arrangement of conductor layers in a laminate of Example 6.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present specification, a numerical range shown using “to” indicates a range including numerical values described before and after “to” as a lower limit value and an upper limit value.

In a numerical range described in a stepwise manner in the present disclosure, an upper limit value or a lower limit value described in one numerical range may be replaced with an upper limit or a lower limit in another numerical range described in a stepwise manner. In addition, in a numerical range described in the present disclosure, an upper limit value or a lower limit value described in the numerical range may be replaced with a value described in an example.

In addition, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

In addition, the term “step” in the present specification indicates not only an independent step but also a step which cannot be clearly distinguished from other steps as long as the intended purpose of the step is achieved.

Furthermore, in the present disclosure, a combination of two or more preferred aspects is the more preferred aspect.

In addition, the weight-average molecular weight (Mw) and the number-average molecular weight (Mn) in the present disclosure are molecular weights converted using polystyrene as a standard substance by performing detection with a gel permeation chromatography (GPC) analysis apparatus using a TSKgel SuperHM-H (trade name, manufactured by Tosoh Corporation) column, a solvent of pentafluorophenol (PFP) and chloroform at a mass ratio of 1:2, and a differential refractometer, unless otherwise specified.

An average particle diameter (for example, D50) of the inorganic filler in the present disclosure is measured using a laser diffraction/scattering-type particle size distribution analyzer. As the laser diffraction/scattering-type particle size distribution analyzer, for example, LA-950V2 manufactured by Horiba, Ltd. is used.

### [Laminate]

The laminate according to the present disclosure includes a dielectric layer having a relative permittivity of more than 3, and conductor layers, in which two or more conductor layers having different sizes are arranged on one surface side of the dielectric layer, a conductor layer different from the two or more conductor layers is disposed on the other surface side of the dielectric layer, and the two or more conductor layers are arranged to be in the same plane and not to be in contact with each other.

The “same plane” means that a surface in contact with the conductor layers is the same plane, and heights from surfaces of the two or more conductor layers may be different from each other.

In the laminate according to the present disclosure, since the two or more conductor layers having different sizes are arranged to be in the same plane and not to be in contact with each other, the laminate is capable of handling a signal of a high-frequency band and is capable of reducing a size of an antenna module to be formed.

On the other hand, WO2023/120467A and WO2023/145327A do not disclose arrangement of two or more conductor layers having different sizes to be in the same plane and not to be in contact with each other. In particular, in WO2023/120467A, it is considered that the first radiator and the second radiator are disposed in the up-down direction, and thus a propagation loss of radio waves is large.

<Dielectric layer>

The laminate according to the present disclosure includes a dielectric layer having a relative permittivity of more than 3.

The relative permittivity of the dielectric layer is preferably 4.5 to 1,000, preferably 5 to 500, more preferably 10 to 100, still more preferably more than 10 and 100 or less, and most preferably 20 to 80.

By setting the relative permittivity in the above-described range, size of the conductor layers formed on the dielectric layer can be designed to be small. Since a spacing between the conductor layers can be increased, the number of conductor layers can be increased or an interaction between the conductor layers can be reduced. A degree of freedom in design is increased, and an energy efficiency can be improved.

From the viewpoint of reducing an energy loss on a substrate and improving an energy efficiency of a device, it is preferable that, in a case where a relative permittivity is indicated as T and a dielectric loss tangent is indicated as D, the dielectric layer satisfies the following expression A.

T^{0.5}×D≤0.10 Expression A

The “T^{0.5}×D” is preferably 0.10 or less, more preferably 0.050 or less, and still more preferably 0.020 or less. In addition, from the viewpoint of achieving mechanical properties of the material, the “T^{0.5}×D” is preferably 0.0001 or more, and more preferably 0.0010 or more.

In addition, a dielectric loss tangent of the dielectric layer is preferably 0.03 or less, more preferably less than 0.01, still more preferably 0.0001 to 0.009, and most preferably 0.001 to 0.008.

In the present disclosure, the relative permittivity and the dielectric loss tangent are measured by the following method.

The relative permittivity and the dielectric loss tangent are measured by a resonant perturbation method at a frequency of 10 GHz. A 10 GHz cavity resonator (“CP531” manufactured by Kanto Electronic Application & Development Inc.) is connected to a network analyzer (“E8363B” manufactured by Agilent Technology Company), the polymer film is inserted into the cavity resonator, and the measurement is performed from the change in resonance frequency before and after the insertion for 96 hours in an environment of a temperature of 25° C. and a humidity of 60% RH.

From the viewpoint of setting the relative permittivity to be more than 3, the dielectric layer preferably contains an inorganic filler and a resin. In addition, the combination of the relative permittivity and the dielectric loss tangent can be controlled by a kind and a content of the inorganic filler or the resin, an alignment state or an aggregation state of the inorganic filler, and the like.

### (Inorganic Filler)

Examples of the inorganic filler contained in the dielectric layer include barium titanate, strontium titanate, calcium titanate, magnesium titanate, bismuth titanate, zirconium titanate, zinc titanate, titanium dioxide, magnesium oxide, alumina, tantalum pentoxide, and niobium pentoxide.

It is preferable that the inorganic filler includes at least one selected from the group consisting of barium titanate, strontium titanate, calcium titanate, magnesium titanate, bismuth titanate, zirconium titanate, zinc titanate, titanium dioxide, magnesium oxide, alumina, tantalum pentoxide, and niobium pentoxide. Among these, it is more preferable that the inorganic filler is barium titanate or titanium oxide.

The inorganic filler preferably has a relative permittivity of 6 to 20,000 and more preferably has a relative permittivity of 20 to 20,000, at 25° C. and a frequency of 10 GHz.

From the viewpoint of achieving both alignment state and dielectric characteristics, an average particle diameter of the inorganic filler is preferably 0.01 μm to 10 μm, more preferably 0.02 μm to 2 μm, and particularly preferably 0.03 μm to 5 μm.

The average particle diameter is measured using a laser diffraction/scattering-type particle size distribution analyzer. As the laser diffraction/scattering-type particle size distribution analyzer, for example, LA-950V2 manufactured by Horiba, Ltd. is used.

A shape of the inorganic filler is not particularly limited, and may be amorphous or spherical. From the viewpoint of increasing a content of the inorganic filler in the dielectric layer to improve the relative permittivity of the dielectric layer, the shape of the inorganic filler is preferably spherical.

In the dielectric layer, it is preferable that a ratio (Do/Di) of the number (Do) of inorganic fillers per unit area in a thickness direction to the number (Di) of inorganic fillers per unit area in an in-plane direction is 0.5 or more.

For example, in a case where the inorganic filler is aligned in the in-plane direction, Di increases and Do decreases, and thus Do/Di decreases. In a case where the inorganic filler is aligned in the thickness direction, Di decreases and Do increases, and thus Do/Di increases.

In a step of forming the dielectric layer, by controlling the alignment state of the inorganic filler such that Do/Di is 0.5 or more, the relative permittivity and the dielectric loss tangent can be set in suitable ranges. Do/Di is preferably 0.7 to 1,000, more preferably 0.85 to 100, and still more preferably 0.9 to 10.

In a case where Do/Di is 0.5 or more, the inorganic filler is moderately aligned in the thickness direction, so that a dielectric amount in an electric field direction is increased, and the relative permittivity is efficiently increased. On the other hand, since the dielectric loss tangent changes depending on the content of the inorganic filler, the alignment of the inorganic filler in the thickness direction is promoted, so that the relative permittivity and the dielectric loss tangent are set in suitable ranges.

Di and Do are measured by the following method.

The dielectric layer is cut with a microtome. The number of inorganic fillers per unit area is measured by a morphological observation using a scanning electron microscope. The ratio (Do/Di) is calculated from the obtained Di and Do.

The inorganic filler contained in the dielectric layer may be only one kind or two or more kinds.

From the viewpoint of achieving both dielectric characteristics and mechanical properties, a content of the inorganic filler is preferably 10% by volume to 90% by volume, more preferably 30% by volume to 80% by volume, and still more preferably 50% by volume to 70% by volume.

In addition, the inorganic filler may be subjected to a surface treatment with an inorganic substance or an organic substance. Examples of a method for the surface treatment include (1) modification by coating, (2) topochemical modification, (3) modification by a mechanochemical reaction, (4) modification by encapsulation, and (5) irradiation with radiation.

### (Resin)

Examples of the resin contained in the dielectric layer include a thermoplastic resin, a thermoplastic elastomer, a semicured product or a cured product of a thermosetting resin, and a semicured product or a cured product of a thermosetting elastomer.

It is preferable that the resin includes at least one selected from the group consisting of a thermoplastic resin, a thermoplastic elastomer, a semicured product of a thermosetting resin, a cured product of a thermosetting resin, a semicured product of a thermosetting elastomer, and a cured product of a thermosetting elastomer.

Examples of the thermoplastic resin include a polyester resin (including liquid crystal polymers), a cyanate resin, a coumarone resin, a polyurethane resin, a (meth)acrylic resin, a polystyrene resin, a fluororesin, a polyimide resin, a fluorinated polyimide resin, a polyamide resin, a polyamideimide resin, a polyetherimide resin, a cellulose acylate resin, a polyether ether ketone resin, a polycarbonate resin, a polyolefin resin (for example, a polyethylene resin, a polypropylene resin, a resin consisting of a cyclic olefin copolymer, and an alicyclic polyolefin resin), a polyarylate resin, a polyether sulfone resin, a polysulfone resin, a fluorene ring-modified polycarbonate resin, an alicyclic ring-modified polycarbonate resin, and a fluorene ring-modified polyester resin.

Examples of the thermoplastic elastomer include an elastomer containing a constitutional unit derived from styrene (polystyrene-based elastomer), a polyester-based elastomer, a polyolefin-based elastomer, a polyurethane-based elastomer, a polyamide-based elastomer, a polyacryl-based elastomer, a silicone-based elastomer, and a polyimide-based elastomer. The thermoplastic elastomer may be a hydrogenated product.

Examples of the polystyrene-based elastomer include a styrene-butadiene-styrene block copolymer (SBS), a styrene-isoprene-styrene block copolymer (SIS), a polystyrene-poly(ethylene-propylene) diblock copolymer (SEP), a polystyrene-poly(ethylene-propylene)-polystyrene triblock copolymer (SEPS), a styrene-ethylene-butylene-styrene block copolymer (SEBS), a polystyrene-poly(ethylene/ethylene-propylene)-polystyrene triblock copolymer (SEEPS), a styrene-isobutylene-styrene block copolymer (SIBS), and hydrogenated products thereof.

Examples of the thermosetting resin include epoxy resins which are monomers, oligomers, or polymers having two or more epoxy groups in one molecule, and the molecular weight and molecular structure thereof are not particularly limited.

Examples of the epoxy resin include a biphenyl-type epoxy resin; a bisphenol-type epoxy resin such as a bisphenol A-type epoxy resin, a bisphenol F-type epoxy resin, and a tetramethylbisphenol F-type epoxy resin; a stilbene-type epoxy resin; a novolac-type epoxy resin such as a phenol novolac-type epoxy resin and a cresol novolac-type epoxy resin; a polyfunctional epoxy resin such as a trishydroxyphenylmethane-type epoxy resin and an alkyl-modified trishydroxyphenylmethane-type epoxy resin; an aralkyl-type epoxy resin such as a phenol aralkyl-type epoxy resin having a phenylene skeleton and a phenol aralkyl-type epoxy resin having a biphenylene skeleton; a naphthol-type epoxy resin such as a dihydroxynaphthalene-type epoxy resin and an epoxy resin obtained by glycidyl etherifying a dimer of dihydroxynaphthalene; a triazine ring-containing epoxy resin such as triglycidyl isocyanurate and monoallyl diglycidyl isocyanurate; and a bridged cyclic hydrocarbon compound-modified phenol-type epoxy resin such as a dicyclopentadiene-modified phenol-type epoxy resin.

From the viewpoint of improving balance between moisture resistance reliability and moldability, the epoxy resin is preferably at least one selected from the group consisting of a bisphenol-type epoxy resin, a novolac-type epoxy resin, a biphenyl-type epoxy resin, a phenol aralkyl-type epoxy resin, and a triphenylmethane-type epoxy resin; and more preferably at least one selected from the group consisting of a biphenyl-type epoxy resin and a phenol aralkyl-type epoxy resin.

It is preferable that the semicured product of the thermosetting resin and the cured product of the thermosetting resin are obtained by semicuring and curing the above-described thermosetting resin, respectively.

Examples of a curing agent for curing the epoxy resin include amines including linear aliphatic diamines having 2 to 20 carbon atoms, such as ethylenediamine, trimethylenediamine, tetramethylenediamine, and hexamethylenediamine, and metaphenylenediamine, paraphenylenediamine, paraxylene diamine, 4,4′-diaminodiphenylmethane, 4,4′-diaminodiphenylpropane, 4,4′-diaminodiphenyl ether, 4,4′-diaminodiphenyl sulfone, 4,4′-diaminodicyclohexane, bis(4-aminophenyl)phenylmethane, 1,5-diaminonaphthalene, metaxylene diamine, 1,1-bis(4-aminophenyl)cyclohexane, and dicyanodiamide; resol-type phenol resins such as an aniline-modified resol resin and a dimethyl ether resol resin; novolac-type phenol resins such as a phenol novolac resin, a cresol novolac resin, a tert-butylphenol novolac resin, and a nonylphenol novolac resin; polyfunctional phenol resins such as a triphenylmethane-type phenol resin; phenol aralkyl resins such as a phenol aralkyl resin containing a phenylene skeleton and a phenol aralkyl resin containing a biphenylene skeleton; phenol resins having a fused polycyclic structure such as a naphthalene skeleton or an anthracene skeleton; polyoxystyrenes such as poly(paraoxystyrene); acid anhydrides including an alicyclic acid anhydride such as hexahydrophthalic anhydride (HHPA) and methyltetrahydrophthalic anhydride (MTHPA), and an aromatic acid anhydride such as trimellitic acid anhydride (TMA), pyromellitic acid anhydride (PMDA), and benzophenonetetracarboxylic acid dianhydride (BTDA); polymercaptan compounds such as polysulfide, thioester, and thioether; isocyanate compounds such as an isocyanate prepolymer and a blocked isocyanate; and organic acids such as a carboxylic-acid-containing polyester resin.

The curing agent may be used alone or in combination of two or more thereof.

An addition amount of the curing agent is not particularly limited, but is, for example, preferably 0.1% by mass to 20% by mass, more preferably 0.5% by mass to 10% by mass, and still more preferably 1% by mass to 5% by mass with respect to the total content of the resin and the curing agent.

Examples of the thermosetting elastomer include silicone rubber, fluororubber, and urethane rubber.

Examples of the silicone rubber include vinyl group-containing organopolysiloxane.

It is preferable that the semicured product of the thermosetting elastomer and the cured product of the thermosetting elastomer are obtained by semicuring and curing the above-described thermosetting elastomer, respectively.

Among these, the resin preferably includes a liquid crystal polymer.

The type of the liquid crystal polymer is not particularly limited, and a known liquid crystal polymer can be used.

In addition, the liquid crystal polymer may be a thermotropic liquid crystal polymer which exhibits liquid crystallinity in a molten state, or may be a lyotropic liquid crystal polymer which exhibits liquid crystallinity in a solution state. In addition, in a case of the thermotropic liquid crystal, it is preferable that the liquid crystal is melted at a temperature of 450° C. or lower.

Examples of the liquid crystal polymer include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

In addition, as the liquid crystal polymer, from the viewpoint of liquid crystallinity, a polymer having an aromatic ring is preferable, and an aromatic polyester or an aromatic polyester amide is more preferable.

The liquid crystal polymer may be a polymer in which a bond derived from an isocyanate, such as an imide bond, a carbodiimide bond, and an isocyanurate bond, is further introduced into the aromatic polyester or the aromatic polyester amide.

In addition, it is preferable that the liquid crystal polymer is a wholly aromatic liquid crystal polymer formed of only an aromatic compound as a raw material monomer.

Examples of the liquid crystal polymer include the following liquid crystal polymers.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine;
2) a liquid crystal polymer obtained by polycondensing a plurality of types of aromatic hydroxycarboxylic acids;
3) a liquid crystal polymer obtained by polycondensing (i) an aromatic dicarboxylic acid and (ii) at least one compound selected from the group consisting of an aromatic diol, an aromatic hydroxyamine, and an aromatic diamine;
4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

A melting point of the liquid crystal polymer is preferably higher than 260° C., more preferably higher than 260° C. and 350° C. or lower, and still more preferably higher than 260° C. and 330° C. or lower.

In the present disclosure, the melting point is measured using a differential scanning calorimetry device. For example, the measurement is performed using product name “DSC-60A Plus” (manufactured by Shimadzu Corporation). A temperature increase rate in the measurement is set to 10° C./min.

A weight-average molecular weight of the liquid crystal polymer is preferably 1,000,000 or less, more preferably 3,000 to 300,000, still more preferably 5,000 to 100,000, and particularly preferably 5,000 to 30,000.

The liquid crystal polymer preferably includes aromatic polyester amide from the viewpoint of further decreasing the dielectric loss tangent. The aromatic polyester amide is resin having at least one aromatic ring and having an ester bond and an amide bond. Among these, from the viewpoint of heat resistance, the aromatic polyester amide is preferably a wholly aromatic polyester amide.

The aromatic polyester amide is preferably a crystalline polymer. It is preferable that the liquid crystal polymer includes a crystalline aromatic polyester amide. In a case where the aromatic polyester amide is crystalline, the dielectric loss tangent is further decreased.

The crystalline polymer refers to a polymer having a clear endothermic peak, not a stepwise endothermic amount changed, in differential scanning calorimetry (DSC). Specifically, for example, it means that a half-width of an endothermic peak in measuring at a temperature increase rate of 10° C./min is within 10° C. A polymer in which the half-width exceeds 10° C. and a polymer in which the clear endothermic peak is not recognized are distinguished as an amorphous polymer from a crystalline polymer.

The aromatic polyester amide preferably contains a constitutional unit represented by Formula 1, a constitutional unit represented by Formula 2, and a constitutional unit represented by Formula 3.

—O—Ar¹—CO— Formula 1

—CO—Ar²—CO— Formula 2

—NH—Ar³—O— Formula 3

In Formula 1 to Formula 3, Ar¹, Ar², and Ar³ each independently represent a phenylene group, a naphthylene group, or a biphenylylene group.

Hereinafter, the constitutional unit represented by Formula 1 and the like are also referred to as “unit 1” and the like.

The unit 1 can be introduced, for example, using aromatic hydroxycarboxylic acid as a raw material.

The unit 2 can be introduced, for example, using aromatic dicarboxylic acid as a raw material.

The unit 3 can be introduced, for example, using aromatic hydroxylamine as a raw material.

Here, the aromatic hydroxycarboxylic acid, the aromatic dicarboxylic acid, the aromatic diol, and the aromatic hydroxylamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid and an aromatic hydroxyamine, include a derivative (acylated product) obtained by acylating a hydroxy group and converting the acylated group into an acyloxy group.

For example, the aromatic hydroxycarboxylic acid and the aromatic hydroxylamine can be each replaced with an acylated product by acylating a hydroxy group and converting the acylated group into an acyloxy group.

Examples of a polycondensable derivative of the aromatic hydroxylamine include a substance (acylated product) obtained by acylating an amino group to convert the amino group into an acylamino group.

For example, the aromatic hydroxyamine can be replaced with an acylated product by acylating an amino group and converting the acylated group into an acylamino group.

In Formula 1, Ar¹ is preferably a p-phenylene group, a 2,6-naphthylene group, or a 4,4′-biphenylylene group, and more preferably a 2,6-naphthylene group.

In a case where Ar¹ is a p-phenylene group, the unit 1 is, for example, a constitutional unit derived from p-hydroxybenzoic acid.

In a case where Ar¹ is a 2,6-naphthylene group, the unit 1 is, for example, a constitutional unit derived from 6-hydroxy-2-naphthoic acid.

In a case where Ar¹ is a 4,4′-biphenylylene group, the unit 1 is, for example, a constitutional unit derived from 4′-hydroxy-4-biphenylcarboxylic acid.

In Formula 2, Ar² is preferably a p-phenylene group, an m-phenylene group, or a 2,6-naphthylene group, and more preferably an m-phenylene group.

In a case where Ar² is a p-phenylene group, the unit 2 is, for example, a constitutional unit derived from terephthalic acid.

In a case where Ar² is an m-phenylene group, the unit 2 is, for example, a constitutional unit derived from isophthalic acid.

In a case where Ar² is a 2,6-naphthylene group, the unit 2 is, for example, a constitutional unit derived from 2,6-naphthalenedicarboxylic acid.

In Formula 3, Ar³ is preferably a p-phenylene group or a 4,4′-biphenylylene group, and more preferably a p-phenylene group.

In a case where Ar³ is a p-phenylene group, the unit 3 is, for example, a constitutional unit derived from p-aminophenol.

In a case where Ar³ is a 4,4′-biphenylylene group, the unit 3 is, for example, a constitutional unit derived from 4-amino-4′-hydroxybiphenyl.

With respect to the total content of the unit 1, the unit 2, and the unit 3, a content of the unit 1 is preferably 30 mol % or more, a content of the unit 2 is preferably 35 mol % or less, and a content of the unit 3 is preferably 35 mol % or less.

The content of the unit 1 is preferably 30 mol % to 80 mol %, more preferably 30 mol % to 60 mol %, and particularly preferably 30 mol % to 40 mol % with respect to the total content of the unit 1, the unit 2, and the unit 3.

The content of the unit 2 is preferably 10 mol % to 35 mol %, more preferably 20 mol % to 35 mol %, and particularly preferably 30 mol % to 35 mol % with respect to the total content of the unit 1, the unit 2, and the unit 3.

The content of the unit 3 is preferably 10 mol % to 35 mol %, more preferably 20 mol % to 35 mol %, and particularly preferably 30 mol % to 35 mol % with respect to the total content of the unit 1, the unit 2, and the unit 3.

The total content of the constitutional units is a value obtained by totaling a substance amount (mol) of each constitutional unit. The substance amount of each constitutional unit is calculated by dividing a mass of each constitutional unit constituting the aromatic polyester amide by a formula weight of each constitutional unit.

In a case where a ratio of the content of the unit 2 to the content of the unit 3 is expressed as [Content of unit 2]/[Content of unit 3] (mol/mol), the ratio is preferably 0.9/1 to 1/0.9, more preferably 0.95/1 to 1/0.95, and still more preferably 0.98/1 to 1/0.98.

The aromatic polyester amide may contain two kinds or more of the unit 1 to the unit 3 each independently. In addition, the aromatic polyester amide may have other constitutional units other than the unit 1 to the unit 3. A content of other constitutional units is preferably 10% by mole or less and more preferably 5% by mole or less with respect to the total content of all constitutional units.

The aromatic polyester amide is preferably produced by subjecting a source monomer corresponding to the constitutional unit constituting the aromatic polyester amide to melt polymerization.

A weight-average molecular weight of the aromatic polyester amide is preferably 1,000,000 or less, more preferably 3,000 to 300,000, still more preferably 5,000 to 100,000, and particularly preferably 5,000 to 30,000.

The resin contained in the dielectric layer may be only one kind or two or more kinds.

From the viewpoint of achieving both dielectric characteristics and mechanical properties, a content of the resin is preferably 10% by volume to 90% by volume, more preferably 20% by volume to 70% by volume, and still more preferably 30% by volume to 50% by volume.

The dielectric layer may contain an additive in addition to the inorganic filler and the resin. Examples of the additive include a polymerization initiator, a dispersant, a surfactant, a crosslinking agent, and an antioxidant.

An average thickness of the dielectric layer is not particularly limited, and from the viewpoint of handleability, it is preferably 30 μm to 200 mm, more preferably 40 μm to 100 mm, and still more preferably 50 μm to 50 mm.

The average thickness of the dielectric layer is measured at five optional sites using an adhesive film thickness meter, for example, an electronic micrometer (product name, “KG3001A”, manufactured by Anritsu Corporation), and an average value of the measured values is defined as the thickness of the film.

### <Manufacturing Method of Dielectric Layer>

A manufacturing method of the dielectric layer is not particularly limited, and a known method can be referred to.

Suitable examples of the film forming method include a co-casting method, a multi-layer coating method, and a co-extrusion method, and the film can also be produced using a dispenser or the like.

In a case where a multilayer structure is produced by a co-casting method or a multi-layer coating method, it is preferable to perform the co-casting method or the multi-layer coating method using a solution or the like, which is obtained by dissolving or dispersing each component of each layer in a solvent.

It is preferable that the manufacturing method of the dielectric layer includes a step of performing dispersion treatment with a beads mill to prepare a solution, and a step of forming a film using the solution.

By performing the dispersion treatment with the beads mill, an effect of reducing and homogenizing aggregates of particles can be obtained.

It is preferable that a bead diameter of beads used in the beads mill is larger than an average particle diameter of the particles used for preparing the solution. The bead diameter is, for example, 0.1 mm to 5 mm.

Examples of the solvent include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoramide and tri-n-butyl phosphate. Among these, two or more kinds thereof may be used in combination.

From the viewpoint of low corrosiveness and satisfactory handleability, a solvent containing, as a main component, an aprotic compound, particularly an aprotic compound having no halogen atom is preferable as the solvent, and the proportion of the aprotic compound in the entire solvent is preferably 50% by mass to 100% by mass, more preferably 70% by mass to 100% by mass, and particularly preferably 90% by mass to 100% by mass. In addition, from the viewpoint of easily dissolving the liquid crystal polymer, as the above-described aprotic compound, it is preferable to use an amide such as N,N-dimethylformamide, N,N-dimethylacetamide, tetramethylurea, and N-methylpyrrolidone, or an ester such as γ-butyrolactone; and it is more preferable to use N,N-dimethylformamide, N,N-dimethylacetamide, or N-methylpyrrolidone.

In addition, as the solvent, from the viewpoint of easily dissolving the liquid crystal polymer, a solvent containing a compound having a dipole moment of 3 to 5 as a main component is preferable, and a proportion of the compound having a dipole moment of 3 to 5 in the entire solvent is preferably 50% by mass to 100% by mass, more preferably 70% by mass to 100% by mass, and particularly preferably 90% by mass to 100% by mass.

It is preferable to use the compound having a dipole moment of 3 to 5 as the above-described aprotic compound.

In addition, as the solvent, from the viewpoint of ease of removal, a solvent containing, as a main component, a compound having a boiling point of 220° C. or lower at 1 atm is preferable, and a proportion of the compound having a boiling point of 220° C. or lower at 1 atm in the entire solvent is preferably 50% by mass to 100% by mass, more preferably 70% by mass to 100% by mass, and particularly preferably 90% by mass to 100% by mass.

It is preferable to use the compound having a boiling point of 220° C. or lower at 1 atm as the above-described aprotic compound.

In addition, in a case where the manufacturing method of the dielectric layer is the co-casting method, the multilayer coating method, the co-extrusion method, or the like described above, a support may be used in the manufacturing method.

Examples of the support include a metal drum, a metal band, a glass plate, a resin film, and a metal foil. Among these, the support is preferably a metal drum, a metal band, or a resin film.

In addition, the support may have a surface treatment layer formed on the surface so that the support can be easily peeled off. Hard chrome plating, a fluororesin, or the like can be used as the surface treatment layer.

An average thickness of the support is not particularly limited, but is preferably 25 μm to 75 μm and more preferably 50 μm to 75 μm.

In addition, a method for removing at least a part of the solvent from a cast or applied film-like composition (a coating film) is not particularly limited, and a known drying method can be used.

### <Conductor Layer>

The laminate according to the present disclosure includes a conductor layer. Two or more conductor layers having different sizes are arranged on one surface side of the dielectric layer, and a conductor layer different from the two or more conductor layers is disposed on the other surface side of the dielectric layer. In addition, the two or more conductor layers are arranged to be in the same plane and not to be in contact with each other.

In the present disclosure, the conductor layer is a layer containing a material (conductive material) having conductivity. The conductivity means a property of a volume resistivity of less than 10⁸ Ωcm.

The “different sizes” means that the sizes only need not be exactly identical to each other, and that the size difference may be appropriately selected in accordance with the signal frequency.

The “two or more having different sizes” may be similar shapes or different shapes in which the sizes are different from each other.

The conductive material preferably contains a metal, and more preferably is one or more selected from the group consisting of gold, silver, platinum, copper, and aluminum. Among these, from the viewpoint of high conductivity and suppression of ion migration, the conductive material is particularly preferably at least one of gold or copper, and most preferably copper.

From the viewpoint of high conductivity, the conductor layer preferably has a surface roughness Rc of 1 μm or less, and more preferably has a surface roughness Rc of 0.7 μm or less on the dielectric layer side. From the viewpoint of improving adhesiveness to the dielectric layer, the lower limit value of the surface roughness Rc is preferably 0.01 μm.

In the present disclosure, the surface roughness Rc is measured by the following method.

The laminate is cut with a microtome to expose a cross section. An average height Rc of an interface of the conductor layer on the dielectric layer side is measured in accordance with JIS B 0601:2001. An evaluation length is set to 500 μm.

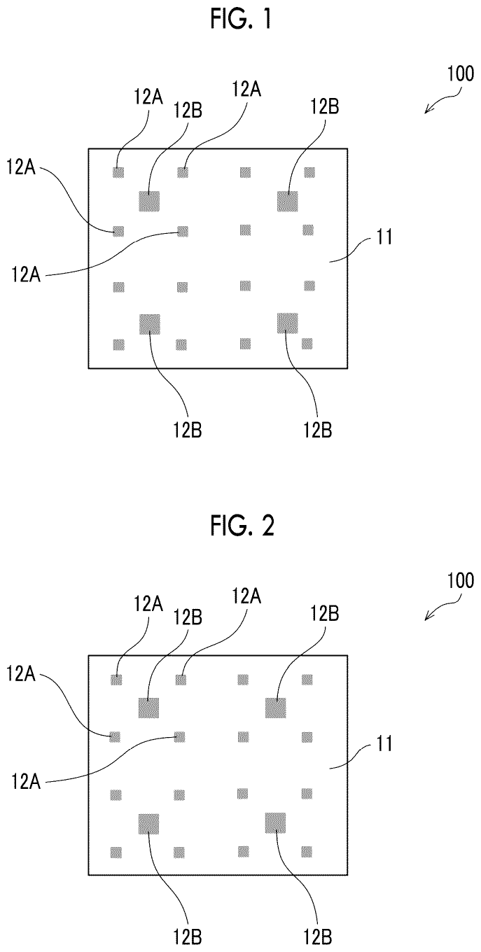

Hereinafter, the two or more conductor layers having different sizes, which are arranged on one surface side of the dielectric layer, will be described with reference to FIG. 1.

FIG. 1 is a schematic plan view schematically showing an arrangement of the conductor layers in the laminate according to the present disclosure.

As shown in FIG. 1, in a laminate 100, a plurality of conductor layers 12A and 12B having different sizes are arranged on a dielectric layer 11, respectively.

It is preferable that the conductor layers 12A and 12B have different signal frequencies.

A size of the conductor layer 12A is smaller than a size of the conductor layer 12B, and the conductor layer 12A corresponds to radio waves having a higher frequency than the conductor layer 12B.

A planar shape of the conductor layers 12A and 12B is not particularly limited, and may be a quadrangular shape (for example, square, rectangle, or the like) as shown in FIG. 1 or a circular shape.

It is sufficient that the conductor layers 12A and 12B have different sizes, and they may have the same planar shape or different planar shapes.

In a case where the conductor layer has a square shape, a length of one side is, for example, 0.2 mm to 130 mm.

For example, the conductor layer 12A has a square shape having one side of 1.3 mm in a plan view, and the conductor layer 12B has a square shape having one side of 2.8 mm in a plan view.

The conductor layers 12A and 12B are arranged to be in the same plane and not to be in contact with each other.

It is preferable that the conductor layers 12A are scattered at substantially equal intervals in a lattice shape. Similarly, it is preferable that the conductor layers 12B are also scattered at substantially equal intervals in a lattice shape.

The “scattered at substantially equal intervals” means that the plurality of conductor layers are regularly arranged at equal intervals or at equal intervals with an error of +20% or less.

A distance between adjacent conductor layers is, for example, 5 mm to 360 mm.

For example, a distance between adjacent conductor layers 12A is 10 mm, and a distance between adjacent conductor layers 12B is 21 mm.

The distance between adjacent conductor layers means a distance between centers of the conductor layers.

The distance between adjacent conductor layers is appropriately adjusted depending on the corresponding frequency.

In particular, from the viewpoint of avoiding contact between the conductor layers, it is preferable that the conductor layers 12A and 12B are arranged in a staggered manner.

The arrangement in a staggered manner can be determined by the following method.

A grid line A is drawn by connecting conductor layers of one type (for example, the conductor layers 12A) to each other.

In addition, a grid line B is drawn by connecting conductor layers of the other type (for example, the conductor layers 12B) to each other.

In a case where the grid line A and the grid line B do not overlap with each other in the same axial direction, it is determined that the arrangement is in a staggered manner.

In a case where the conductor layers are connected by a line to draw the grid line, and a part of the lattice shape is missing, it is not determined that the arrangement is in a staggered manner.

In addition, in the laminate according to the present disclosure, a conductor layer different from the above-described two or more conductor layers is disposed on the other surface side of the dielectric layer. The conductor layer functions as a ground layer.

### [Antenna Substrate]

The antenna substrate according to the present disclosure includes the above-described laminate. A patterned antenna can be produced from the above-described laminate by a known method such as photofabrication. A corresponding frequency of the antenna can be appropriately adjusted by designing the pattern, the size of the patch, and the like.

### [Antenna Module]

As one aspect, the antenna module according to the present disclosure is an antenna module which transmits and receives radio waves having a frequency of 6 GHz to 24 GHz, the antenna module including the antenna substrate. As another aspect, the antenna module according to the present disclosure is an antenna module which transmits and receives radio waves having a frequency of 0.5 to 5.9 GHZ, the antenna module including the antenna substrate.

### EXAMPLES

Hereinafter, the present disclosure will be described in more detail with reference to Examples. The materials, the used amounts, the proportions, the treatment contents, the treatment procedures, and the like described in the following examples can be appropriately changed without departing from the gist of the present disclosure. Therefore, the scope of the present disclosure is not limited to the following specific examples.

Details of each material used for producing the laminate are as follows.

### <Inorganic Filler>

F1: pulverized product of barium titanate particles (average particle diameter: 2 μm, relative permittivity: 1,000, dielectric loss tangent: 0.015)
F2: pulverized product of titanium dioxide particles (average particle diameter: 7 μm, relative permittivity: 85, dielectric loss tangent: 0.013)
F3: pulverized product of strontium titanate particles (average particle diameter: 1 μm, relative permittivity: 300, dielectric loss tangent: 0.005)
F4: pulverized product of barium titanate particles (average particle diameter: 4 μm, relative permittivity: 2,000, dielectric loss tangent: 0.100)

### <Resin>

P1: aromatic polyester amide produced by the following production method
P2: mixture (mass ratio: 100:5) of an aromatic polyester amide produced according to the following production method, and an aminophenol-type epoxy resin (product name “jER630”, manufactured by Mitsubishi Chemical Corporation)·
P3: cycloolefin polymer (product name “ZEONEX480R”, manufactured by Zeon Corporation)
   —Synthesis of aromatic polyester amide P1—

940.9 g (5.0 mol) of 6-hydroxy-2-naphthoic acid, 415.3 g (2.5 mol) of isophthalic acid, 377.9 g (2.5 mol) of acetaminophen, and 867.8 g (8.4 mol) of acetic acid anhydride were added to a reactor provided with a stirrer, a torque meter, a nitrogen gas introduction pipe, a thermometer, and a reflux condenser, the gas inside the reactor was replaced with nitrogen gas, and the mixture was heated from room temperature (23° C.; the same applies hereinafter) to 140° C. over 60 minutes while being stirred in a nitrogen gas stream and was refluxed at 140° C. for 3 hours.

Next, the temperature was raised from 150° C. to 300° C. over 5 hours while distilling off by-produced acetic acid and unreacted acetic acid anhydride, and maintained at 300° C. for 30 minutes. Thereafter, the content was taken out from the reactor and was cooled to room temperature. The obtained solid was pulverized by a pulverizer to obtain a powdered aromatic polyester amide Pla. A flow start temperature of the aromatic polyester amide Pla was 193° C. In addition, the aromatic polyester amide Pla was a wholly aromatic polyester amide.

The aromatic polyester amide Pla was subjected to solid polymerization by increasing the temperature from room temperature to 160° C. over 2 hours and 20 minutes in a nitrogen atmosphere, increasing the temperature from 160° C. to 180° C. over 3 hours and 20 minutes, and maintaining the temperature at 180° C. for 5 hours, and then the resultant was cooled. Next, the resultant was pulverized by a pulverizer to obtain a powdered aromatic polyester amide P1b. A flow start temperature of the aromatic polyester amide P1b was 220° C.

The aromatic polyester amide P1b was subjected to solid polymerization by increasing the temperature from room temperature to 180° C. over 1 hour and 25 minutes in a nitrogen atmosphere, increasing the temperature from 180° C. to 255° C. over 6 hours and 40 minutes, and maintaining the temperature at 255° C. for 5 hours, and then the resultant was cooled, thereby obtaining a powdered aromatic polyester amide P1.

A flow start temperature of the aromatic polyester amide P1 was 302° C. In addition, in a case where a melting point of the aromatic polyester amide P1 was measured using a differential scanning calorimetry device, the measured value was 311° C. A dielectric loss tangent of the aromatic polyester amide P1 was 0.003.

### <Copper Foil>

M1: product name “CF-T49A-DS-HD2”, manufactured by Fukuda Metal Foil & Powder Co., Ltd., average thickness: 18 μm, surface roughness Rc: 1.0 μm

M2: product name “CF-T9DA-SV”, manufactured by Fukuda Metal Foil & Powder Co., Ltd., average thickness: 18 μm, surface roughness Rc: 0.7 μm

### <Film>

### (Film for Comparative Example 2)

By a known melt extrusion method, P3 was molded into a sheet shape having a thickness of 600 μm to produce a film for Comparative Example 2.

### (Film for Comparative Example 4)

P4: prepreg of an FR-4 material having a thickness of 109 μm (product name “R-1661”, manufactured by Panasonic Industry Co., Ltd.)
<Double-sided copper-clad laminate>
T1: double-sided copper-clad laminate of an FR-4 material having a thickness of 0.6 mm (product name “R-1766”, manufactured by Panasonic Industry Co., Ltd.)

### [Production of Laminate]

### Example 1

### (Film Formation 1)

The inorganic filler and the resin shown in Table 1 were mixed at contents (% by mass) shown in Table 1, and dispersed with a beads mill to obtain a solution (dispersion liquid).

The obtained solution was fed to a slot die, and the solution was applied onto a copper foil shown in Table 1 by adjusting a flow rate such that an average thickness after drying was 60 μm. The solvent was removed from the coating film by hot air drying to obtain a polymer film (single-sided copper-clad laminate) having a copper layer, and the heat treatment was carried out by heating from 50° C. to 300° C. at a rate of 1° C./min and holding at 300° C. for 2 hours in a nitrogen atmosphere to produce a single-sided copper-clad laminate.

(Film formation 2)

The copper foil of the single-sided copper-clad laminate obtained in the film formation 1 was removed with an aqueous solution of ferric chloride, washed with pure water, and dried to produce a film.

### (Production of Double-Sided Copper-Clad Laminate)

The single-sided copper-clad laminate obtained in the film formation 1 and the film obtained in the film formation 2 were laminated in the order of the single-sided copper-clad laminate of the film formation 1/the film of the film formation 2/the single-sided copper-clad laminate of the film formation 1, such that the copper foil was on the outermost surface. In this case, the number of films of the film formation 2 was adjusted such that the thickness of the dielectric layer was 600 μm.

Lamination was carried out using a laminator (product name “Vacuum laminator V-130”, manufactured by Nikko-Materials Co., Ltd.) under conditions of 140° C. and a laminating pressure of 0.4 MPa for 1 minute to obtain a precursor of a double-sided copper-clad laminate. Furthermore, the obtained precursor of the double-sided copper-clad laminate was subjected to thermocompression bonding using a thermocompression bonding machine (product name “MP-SNL”, manufactured by Toyo Seiki Seisaku-sho, Ltd.) under conditions of 320° C. to produce a double-sided copper-clad laminate.

(Production of laminate)

Next, the copper foil of one surface of the double-sided copper-clad laminate was patterned by a known subtractive method.

Conductor layers 1 were arranged as a square microstrip antenna designed for a resonance frequency of 15 GHz. Conductor layers 2 were arranged as a square microstrip antenna designed for a resonance frequency of 7 GHZ. Sizes of the conductor layers 1 and 2, a distance between the conductor layers 1, and a distance between the conductor layers 2 were adjusted as shown in Table 1. As shown in FIG. 1, a laminate in which the conductor layers 1 having a 4×4 array of patches and the conductor layers 2 having a 2×2 array of patches were arranged in a staggered manner was produced.

### Example 2

In Example 2, a laminate was produced by the same method as in Example 1, except that the distance between the conductor layers 2 was changed, and the conductor layers 1 having a 4×4 array of patches and the conductor layers 2 having a 2×2 array of patches were arranged as shown in FIG. 2.

### Examples 3 to 5

In Examples 3 to 5, a laminate was produced by the same method as in Example 2, except that the kind or content of the inorganic filler and the resin or the kind of the copper foil was changed, and the sizes of the conductor layers 1 and the conductor layers 2 were changed.

### Example 6

In Example 6, a laminate was produced by the same method as in Example 1, except that the arrangement positions of the conductor layers 1 and the conductor layers 2 were changed.

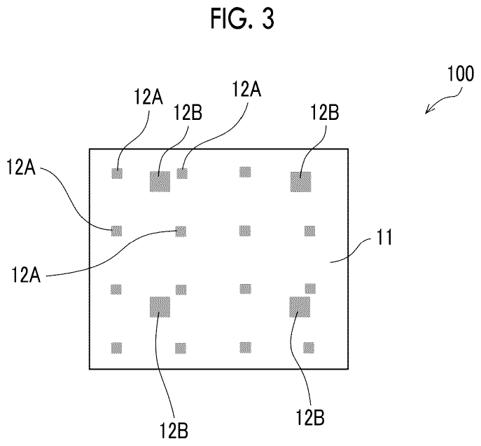

Specifically, as shown in FIG. 3, a laminate in which the conductor layers 1 having 15 patches and the conductor layers 2 having 4 patches were arranged was produced.

### Examples 7 to 9

In Examples 7 to 9, a laminate was produced by the same method as in Example 2, except that the kind and content of the inorganic filler were changed, the sizes of the conductor layers 1 and the conductor layers 2 were changed, and the thickness of the dielectric layer was changed to 1,800 μm.

### Comparative Example 1

A laminate was produced by the same method as in Example 1, except that the double-sided copper-clad laminate T1 was used, and the sizes of the conductor layers 1 and the conductor layers 2 were changed. The conductor layers 1 and the conductor layers 2 partially contacted and were bonded to each other.

### Comparative Example 2

### (Production of Double-Sided Copper-Clad Laminate)

The film for Comparative Example 2 was sandwiched between a pair of copper foils shown in Table 1, and laminated using a laminator (product name “Vacuum laminator V-130”, manufactured by Nikko-Materials Co., Ltd.) under conditions of 140° C. and a laminating pressure of 0.4 MPa for 1 minute to obtain a precursor of a double-sided copper-clad laminate. Furthermore, the obtained precursor of the double-sided copper-clad laminate was subjected to thermocompression bonding using a thermocompression bonding machine (product name “MP-SNL”, manufactured by Toyo Seiki Seisaku-sho, Ltd.) under conditions of 200° C. to produce a double-sided copper-clad laminate.

A laminate was produced by the same method as in Example 1, except that the obtained double-sided copper-clad laminate was used.

### Comparative Example 3

A laminate was produced by the same method as in Example 1, except that the sizes of the conductor layers 1 and the conductor layers 2 were changed. The conductor layer 1 and the conductor layer 2 partially contacted and were joined to each other.

### Comparative Example 4

The copper foil of one surface of the double-sided copper-clad laminate T1 was patterned by a known subtractive method, and the conductor layers 1 were arranged as a square microstrip antenna designed for a resonance frequency of 7 GHz. Using another double-sided copper-clad laminate T1, the copper foil of one surface was removed with an aqueous solution of ferric chloride, the other surface was patterned by a known subtractive method, and the conductor layers 2 were arranged as a square microstrip antenna designed for a resonance frequency of 15 GHZ. The surface on which the conductor layers 1 were arranged and the back surface with the conductor layers 2 were laminated through P4, and heated at 170° C. and 2.94 MPa for 90 minutes to produce a laminate. The conductor layers 1 and the conductor layers 2 were arranged such that the positions of the centers of the conductor layers matched in the in-plane direction.

### <<Evaluation>>

The produced laminate was measured and evaluated as shown below.

### Measurement Method

### [Dielectric Characteristics]

The film obtained by removing the copper foil of the double-sided copper-clad laminate with an aqueous solution of ferric chloride, washing with pure water, and drying was used for measurement.

A relative permittivity and a dielectric loss tangent were measured by a resonant perturbation method at a frequency of 10 GHz. A 10 GHz cavity resonator (“CP531” manufactured by Kanto Electronic Application & Development Inc.) was connected to a network analyzer (“E8363B” manufactured by Agilent Technology Company), the film was inserted into the cavity resonator, and the measurement was performed from the change in resonance frequency before and after the insertion for 96 hours in an environment of a temperature of 25° C. and a humidity of 60% RH, thereby measuring the relative permittivity and the dielectric loss tangent of the film (dielectric layer).

### [Radiation Characteristics]

The laminate was used as a square microstrip antenna, and radiation characteristics at 7 GHz and 15 GHz were measured in terms of radiation angle and radiation efficiency (total radiation power÷input power), and evaluated according to the following standard.

### <Evaluation Standard for Radiation Angle>

A: radiation angle was 40% or less of a single patch (1×1), and directivity was high.
B: radiation angle was more than 40% and 60% or less of the single patch, and directivity was sufficient.
C: radiation angle was more than 60% and 80% or less of the single patch, and directivity was low.
D: no directivity was recognized.

### <Evaluation Standard for Radiation Efficiency>

A: radiation efficiency was-1 dB or more.
B: radiation efficiency was-2 dB or more and less than-1 dB.
C: radiation efficiency was-3 dB or more and less than-2 dB.
D: radiation efficiency was less than-3 dB.

The measurement results and evaluation results are shown in Table 1.

In Table 1, “Size” indicates a length of one side of the conductor layer having a square planar shape. “Interval” indicates a distance between the conductor layers.

In addition, in the column of “Same plane/noncontact”, a case where the condition that the conductor layers 1 and the conductor layers 2 were in the same plane and were arranged not to be in contact with each other was satisfied is indicated as “Y”, and a case where the condition was not satisfied is indicated as “N”.

Furthermore, in a case where the above-described condition was satisfied, it was determined whether or not the conductor layers 1 and the conductor layers 2 were arranged in a staggered manner. A case where the conductor layers 1 and the conductor layers 2 were arranged in a staggered manner is indicated as “Y”, and a case where the conductor layers 1 and the conductor layers 2 were not arranged in a staggered manner is indicated as “N”.

TABLE 1

| | Dielectric layer | | | | | | | | | |
|---|---|---|---|---|---|---|---|---|---|---|
| | Resin | | Inorganic filler | | | | | | | |
| | | Content | | Content | | Dielectric | (Permittivity)^{0.5} × | Conductor layer 1 | | |
| | | (% by | | (% by | Relative | loss | dielectric loss | | Size | Interval |
| | Type | volume) | Type | volume) | permittivity | tangent | tangent | Type | (mm) | (mm) |
| Example 1 | P1 | 30 | F1 | 70 | 38 | 0.01 | 0.062 | M1 | 1.3 | 10 |
| Example 2 | P1 | 30 | F1 | 70 | 38 | 0.01 | 0.062 | M1 | 1.3 | 10 |
| Example 3 | P1 | 30 | F2 | 70 | 20 | 0.004 | 0.018 | M1 | 1.9 | 10 |
| Example 4 | P2 | 50 | F1 | 50 | 20 | 0.008 | 0.036 | M2 | 1.9 | 10 |
| Example 5 | P1 | 50 | F1 | 50 | 20 | 0.007 | 0.031 | M1 | 1.9 | 10 |
| Example 6 | P1 | 30 | F1 | 70 | 38 | 0.01 | 0.062 | M1 | 1.3 | 10 |
| Example 7 | P1 | 30 | F3 | 70 | 34 | 0.004 | 0.023 | M1 | 1.4 | 10 |
| Example 8 | P1 | 50 | F3 | 50 | 18 | 0.004 | 0.017 | M1 | 2.1 | 10 |
| Example 9 | P1 | 65 | F4 | 35 | 18 | 0.025 | 0.106 | M1 | 2.1 | 10 |
| Comparative | — | | | | 4.2 | 0.02 | 0.041 | — | 4.7 | 10 |
| Example 1 | | | | | | | | | | |
| Comparative | P3 | 100 | — | 0 | 2.3 | 0.0002 | 0.00030 | M1 | 1.3 | 10 |
| Example 2 | | | | | | | | | | |
| Comparative | P1 | 30 | F1 | 70 | 38 | 0.01 | 0.062 | M1 | 4.7 | 10 |
| Example 3 | | | | | | | | | | |
| Comparative | — | | | | 4.2 | 0.02 | 0.041 | — | 4.7 | 21 |
| Example 4 | | | | | | | | | | |
| | | | | | | | Radiation | | Radiation | |
| | | Conductor layer 2 | | | Arrangement | | angle | | efficiency | |
| | | Type | Size | Interval | Same plane/ | | 7 | 15 | 7 | 15 |
| | | (mm) | (mm) | (mm) | noncontact | Staggered | GHz | GHz | GHz | GHz |
| | Example 1 | M1 | 2.8 | 21 | Y | Y | A | A | C | C |
| | Example 2 | M1 | 2.8 | 20 | Y | Y | B | A | C | C |
| | Example 3 | M1 | 4.3 | 20 | Y | Y | B | A | A | B |
| | Example 4 | M2 | 4.3 | 20 | Y | Y | B | A | B | B |
| | Example 5 | M2 | 4.3 | 20 | Y | Y | B | A | A | A |
| | Example 6 | M1 | 2.8 | 21 | Y | N | A | C | C | C |
| | Example 7 | M1 | 2.9 | 20 | Y | Y | A | A | A | B |
| | Example 8 | M1 | 4.4 | 20 | Y | Y | B | A | A | A |
| | Example 9 | M1 | 4.4 | 20 | Y | Y | B | A | C | C |
| | Comparative | — | 10.1 | 21 | N | — | D | D | B | B |
| | Example 1 | | | | | | | | | |
| | Comparative | M1 | 2.8 | 21 | Y | Y | D | D | A | A |
| | Example 2 | | | | | | | | | |
| | Comparative | M1 | 10.1 | 21 | N | — | D | D | C | C |
| | Example 3 | | | | | | | | | |
| | Comparative | — | 10.1 | 21 | N | — | C | B | B | B |
| | Example 4 | | | | | | | | | |

From Table 1, in Examples 1 to 9, it was found that, since the laminate included the dielectric layer having a relative permittivity of more than 3, and conductor layers, in which two conductor layers having different sizes were arranged on one surface side of the dielectric layer, a conductor layer different from the two conductor layers was disposed on the other surface side of the dielectric layer, and the two conductor layers were arranged to be in the same plane and not to be in contact with each other, it was possible to handle signals of a plurality of high-frequency bands.

On the other hand, in Comparative Examples 1 and 3, it was found that the radiation characteristics were deteriorated because a part of the two conductor layers was in contact with each other.

In Comparative Example 2, it was found that the radiation characteristics were deteriorated because the relative permittivity of the dielectric layer was less than 3.

In Comparative Example 4, it was found that the radiation characteristics were deteriorated because the two conductor layers were not in the same plane.

The disclosure of Japanese Patent Application No. 2023-150291 filed on Sep. 15, 2023 is incorporated in the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A laminate comprising:
a dielectric layer having a relative permittivity of more than 3; and
conductor layers,
wherein two or more conductor layers having different sizes are arranged on one surface side of the dielectric layer,
a conductor layer different from the two or more conductor layers is disposed on the other surface side of the dielectric layer, and
the two or more conductor layers are arranged to be in the same plane and not to be in contact with each other.

2. The laminate according to claim 1,
wherein, in a case where a relative permittivity is indicated as T and a dielectric loss tangent is indicated as D, the dielectric layer satisfies the following expression A,
T^{0.5}×D≤0.10 Expression A.

3. The laminate according to claim 1,
wherein the two or more conductor layers are arranged in a staggered manner.

4. The laminate according to claim 1,
wherein the dielectric layer has a dielectric loss tangent of less than 0.01.

5. The laminate according to claim 1,
wherein the dielectric layer contains an inorganic filler and a resin.

6. The laminate according to claim 5,
wherein the inorganic filler has a relative permittivity of 6 to 20,000.

7. The laminate according to claim 5,
wherein the inorganic filler includes at least one selected from the group consisting of barium titanate, strontium titanate, calcium titanate, magnesium titanate, bismuth titanate, zirconium titanate, zinc titanate, titanium dioxide, magnesium oxide, alumina, tantalum pentoxide, and niobium pentoxide.

8. The laminate according to claim 5,
wherein, in the dielectric layer, a ratio (Do/Di) of a number (Do) of inorganic fillers per unit area in a thickness direction to a number (Di) of inorganic fillers per unit area in an in-plane direction is 0.5 or more.

9. The laminate according to claim 5,
wherein the resin includes at least one selected from the group consisting of a thermoplastic resin, a thermoplastic elastomer, a semicured product of a thermosetting resin, a cured product of a thermosetting resin, a semicured product of a thermosetting elastomer, and a cured product of a thermosetting elastomer.

10. The laminate according to claim 1,
wherein the conductor layer has a surface roughness Rc of 1 μm or less on a dielectric layer side.

11. The laminate according to claim 1,
wherein the two or more conductor layers have different signal frequencies.

12. An antenna substrate comprising:
the laminate according to claim 1.

13. An antenna module comprising:
the antenna substrate according to claim 12,
wherein the antenna module transmits and receives radio waves having a frequency of 6 GHz to 24 GHz.

14. An antenna module comprising:
the antenna substrate according to claim 12,
wherein the antenna module transmits and receives radio waves having a frequency of 0.5 GHz to 5.9 GHz.
